(19) United States
(12) Patent Application Publication
(10) Pub. No.: US 2026/0366365 A1
(43) Pub. Date: Nov. 19, 2026

(54) LOCKING SEAT AND RETRACTABLE GATE BARRIER HAVING SAME

(71) Applicant: GUANGZHOU TUSUNNY HOME PRODUCTS CO., LTD, Guangzhou (CN)

(72) Inventor: Hongjuan WANG, Guangzhou (CN)

(73) Assignee: GUANGZHOU TUSUNNY HOME PRODUCTS CO., LTD, Guangzhou (CN)

(21) Appl. No.: 19/238,709

(22) Filed: Jun. 16, 2025

(30) Foreign Application Priority Data
May 19, 2025 (CN) 202510645421.8

(51) Int. Cl. E06B 9/08; E06B 9/78; E06B 9/80; E06B 9/90; E06B 11/02

(52) U.S. Cl. CPC E06B 9/08; E06B 9/78; E06B 9/80; E06B 9/90; E06B 11/026; E06B 2009/801

(57) ABSTRACT

The present disclosure discloses a locking seat, the locking seat including: a housing, provided with an accommodating cavity with a lower opening, where an inner bottom wall of the accommodating cavity is provided with a positioning hole; a driving seat, arranged in the accommodating cavity; and a unidirectional adjustment device, configured to rotate the driving seat unidirectionally, where the unidirectional adjustment device includes a torsion spring and a locking structure. A retractable gate barrier is further disclosed. The retractable gate barrier includes a rotating shaft and a locking seat, where a top of the rotating shaft is provided with a mounting groove, a vertically movable insertion rod is arranged in the mounting groove, a cloth is wound around the periphery of the rotating shaft, a U-shaped fixing plate is fixed to an outer end of the cloth, an adjustment structure is arranged at a notch of the U-shaped fixing plate.

### CROSS-REFERENCE TO RELATED APPLICATIONS

This application claims priority to Chinese Patent Application No. 202510645421.8, filed on May 19, 2025, which is incorporated herein by reference in its entirety.

### TECHNICAL FIELD

The present disclosure relates to the field of gate barrier products, and in particular, to a locking seat and a retractable gate barrier having the same.

### BACKGROUND

A gate barrier is a structure commonly used in a room or courtyard to separate space. With arrangement of the gate barrier, space partitions for different purposes can be formed in the room or courtyard.

In related technologies, conventional gate barriers are mainly divided into folding gate barriers and retractable gate barriers. The folding gate barriers are mostly mesh cloth gate barriers with double doors. The folding gate barriers are relatively large in size, and not only occupy large space but also are difficult to transport. The retractable gate barrier mainly includes a rotating drum and a separation cloth that is wound in the rotating drum through a torsion spring. The retractable gate barrier is relatively small in size, but a torsion force of the torsion spring needs to be overcame when the separation cloth in the rotating drum is pulled out to divide space. Further, as the separation cloth is pulled out longer, the torsion force to be overcome will be greater, which is extremely unfriendly to users with less strength. If the hand is separated from the separation cloth due to negligent operation in the process of pulling out the separation cloth, the separation cloth may be rapidly wound into the rotating drum due to the torsion force of the torsion spring. In this process, the separation cloth may swing and be irregularly wound due to factors such as the torsion force of the torsion spring and gravity, and the separation cloth in swinging and irregular winding is extremely dangerous, which affects personal safety of people near the gate barrier in an environment, and needs to be improved urgently.

### SUMMARY

A main objective of the present disclosure is to provide a locking seat and a retractable gate barrier having the same. The gate barrier is relatively small in size and high in operation safety.

To implement the foregoing objective, the present disclosure provides a locking seat, including:
a housing, provided with an accommodating cavity with a lower opening, where an inner bottom wall of the accommodating cavity is provided with a positioning hole;
a driving seat, arranged in the accommodating cavity; and
a unidirectional adjustment device, configured to rotate the driving seat unidirectionally.

Preferably, the unidirectional adjustment device includes an adjustment ratchet wheel arranged on the driving seat, and an adjustment pawl swingably mounted on the housing. The adjustment pawl moves toward the adjustment ratchet wheel.

Preferably, the adjustment pawl is provided with a pivoting portion. The adjustment pawl is provided with a positioning portion arranged at an end thereof distal from the pivoting portion. A first abutting spring is arranged between the positioning portion and the housing. One end of the first abutting spring abuts against the positioning portion, and another end abuts against the housing, whereby the first abutting spring applies an elastic force to bias the adjustment pawl toward the adjustment ratchet wheel.

Preferably, the unidirectional adjustment device includes:
a torsion spring in a pre-tensioned state; wherein an inner end of the torsion spring is connected to the driving seat, and an outer end is connected to an inner wall of the accommodating cavity; and a locking structure, movably connected between a first position and a second position of the driving seat for vertical movement;
when the locking structure is in the first position, the locking structure is inserted into and locked in the positioning hole, so that the driving seat and the torsion spring are locked; and
after an external component pushes the locking structure to switch from the first position to the second position, the locking structure disengages from the positioning hole, whereupon the driving seat rotates under torsion of the torsion spring, driving the external component.

Preferably, the driving seat includes:
a drum body extending vertically from top to bottom, wherein a lower port of the drum body faces the lower opening of the accommodating cavity; and
a support plate, vertically arranged in the drum body, and fixed to an inner wall of the drum body along a radial direction of the drum body, where the locking structure is located on an inner side of the drum body, and movably connected to the support plate.

Preferably, a plate surface of the support plate is provided with an elongated hole extending up and down, and the locking structure includes:
a connecting portion, disposed through the elongated hole, and is configured to slide vertically within the elongated hole; and
insertion portions, which are respectively arranged at two ends of the connecting portion and configured to be inserted into the positioning hole, and a gap is defined between the insertion portion and the support plate.

Preferably, the locking structure further includes an adjustment portion. The adjustment portion is connected to the top of the insertion portion. The top end of the adjustment portion extends out of the housing.

Preferably, the top of a lower cantilevered portion and the bottom of an upper cantilevered portion of the housing are provided with limiting grooves configured to mount an external component, and the limiting grooves have side openings in communication with a side wall surface of the housing.

A retractable gate barrier, including a rotating shaft and a locking seat, where
a top of the rotating shaft is provided with a mounting groove, and a vertically movable insertion rod is arranged in the mounting groove; and
a cloth is wound around the periphery of the rotating shaft, a U-shaped fixing plate is fixed to an outer end of the cloth, a notch of the U-shaped fixing plate faces the rotating shaft, an adjustment structure is arranged at the notch of the U-shaped fixing plate, when pressed, the adjustment structure is triggered to drive the insertion rod to push the locking structure upward along a lower opening, to switch from a first position to a second position, so that the driving seat drives the rotating shaft to rotate under torsion of the torsion spring to tension the cloth.

Preferably, the cloth is provided with an interlayer therein. The adjustment structure includes a traction rope. One end of the traction rope penetrates through a side wall of the rotating shaft and extends downward to connect a bottom of the insertion rod, and another end extends out of the interlayer of the cloth and is connected to an outer edge of a cantilevered end of the U-shaped fixing plate after crossing the notch of the U-shaped fixing plate.

Preferably, an upper end of the insertion rod is configured as a U-shaped plug structure, and the U-shaped plug structure is capable of being inserted between the support plate and the insertion portion along the lower opening and pushing the connecting portion.

Preferably, the retractable gate barrier further includes a positioning post fixed to a ground foundation. An outer peripheral surface of the positioning post is matched with the notch of the U-shaped fixing plate. When the U-shaped fixing plate is pulled to the outer peripheral surface of the positioning post, the adjustment structure is triggered.

Preferably, two rotating shafts and two locking seats are provided, and the each of the two rotating shafts corresponds to a respective one of the two locking seats. The respective adjustment structures are triggered when the U-shaped fixing plates in the two rotating shafts are clamped together.

The technical solution of the present disclosure uses design of a retractable gate barrier, and implements small size of the gate barrier in the form of winding the cloth. In a process of pulling out the cloth (that is, the separation cloth) of the retractable gate barrier, the torsion spring does not participate in operation, and it is unnecessary to overcome the torsion force in the process of pulling out the cloth, which is beneficial for operation of users with less strength. After the cloth is pulled to a suitable position, by buckling the U-shaped fixing plate at the outer end of the cloth on a structural member at a target position (for example, on the positioning post), the adjustment structure can be triggered, so that the rotating shaft is prevented from being detached and is locked in the locking seat, and the torsion spring and the driving seat are unlocked, and therefore, the driving seat drives the rotating shaft to rotate through the torsion force of the torsion spring (this rotating direction is opposite to an unwinding direction of the cloth). Further, the U-shaped fixing plate at the end of the cloth is in a buckled state, so that the cloth is in a tensioned state due to the torsion force of the torsion spring, leading to an extremely simple and safe operation process.

### BRIEF DESCRIPTION OF THE DRAWINGS

FIG. 1 is an exploded view of a locking seat according to Embodiment one;

FIG. 2 is a schematic structural diagram of a gate barrier according to Embodiment one;

FIG. 3 is a sectional view of a side of a gate barrier according to Embodiment one;

FIG. 4 is a schematic structural diagram of a folding rod according to Embodiment one;

FIG. 5 is a schematic structural diagram of a locking seat;

FIG. 6 is a partial sectional view of a locking seat;

FIG. 7 is a sectional view of a locking seat and a rotating shaft;

FIG. 8 is a schematic structural diagram of a gate barrier;

FIG. 9 is a schematic structural diagram of an end of a cloth;

FIG. 10 is an exploded view of a driving seat and a locking structure;

FIG. 11 is a schematic diagram of a gate barrier with a positioning post; and

FIG. 12 is a schematic diagram with double locking seats.

In the figures: 1, housing; 1-1, accommodating cavity; 1-2, positioning hole; 1-3, limiting groove; 2, driving seat; 2-1, drum body; 2-2, support plate; 2-3, elongated hole; 3, torsion spring; 4, locking structure; 4-1, connecting portion; 4-2, insertion portion; 4-3, adjustment portion; 5, rotating shaft; 6, insertion rod; 7, cloth; 8, U-shaped fixing plate; 9, traction rope; 10, positioning post; 11, adjustment ratchet wheel; 12, adjustment pawl; 13, positioning portion; 14, first abutting spring; 15, pivoting portion; 16, unlocking device; 17, adjustment device; 18, ejector rod; 19, button; 20, first rack; 21, second rack; 22, gear; 23, second abutting spring; 24, mounting seat; 25, folding rod; 26, positioning pin; 27, third abutting spring; 28, rod body; 29, slope portion; 30, adapter.

### DETAILED DESCRIPTION OF THE EMBODIMENTS

The technical solutions in the embodiments of the present disclosure will be clearly and completely described below with reference to the accompanying drawings. Obviously, the described embodiments are merely some rather than all of the embodiments of the present disclosure. Based on the embodiments of the present disclosure, all other embodiments obtained by those of ordinary skill in the art without creative efforts fall within the scope of protection of the present disclosure.

It should be noted that if the embodiments of the present disclosure involve directional indications (such as up, down, left, right, front, back, top, bottom, inside, outside, vertical, horizontal, longitudinal, counterclockwise, clockwise, circumferential, radial, axial, and the like), the directional indication is merely intended to explain the relative position relationship, movement status, or the like between components in a certain specific posture (as shown in the figures). If the specific posture changes, the directional indication also changes accordingly.

In addition, if the embodiments of the present disclosure involve the description of "first", "second", or the like, the description of "first", "second", or the like is merely intended for a purpose of description, and should not be understood as an indication or implication of relative importance or implicit indication of a quantity of indicated technical features. Therefore, a feature limited by "first", "second" may explicitly or implicitly include at least one feature. In addition, technical solutions of the embodiments may be combined with each other, but must be based on the fact that the technical solutions can be implemented by those of ordinary skill in the field. When the technical solutions are contradictory in combination or cannot be implemented, it should be considered that such a combination of the technical solutions does not exist and is not within the scope of protection of the present disclosure.

### Embodiment One

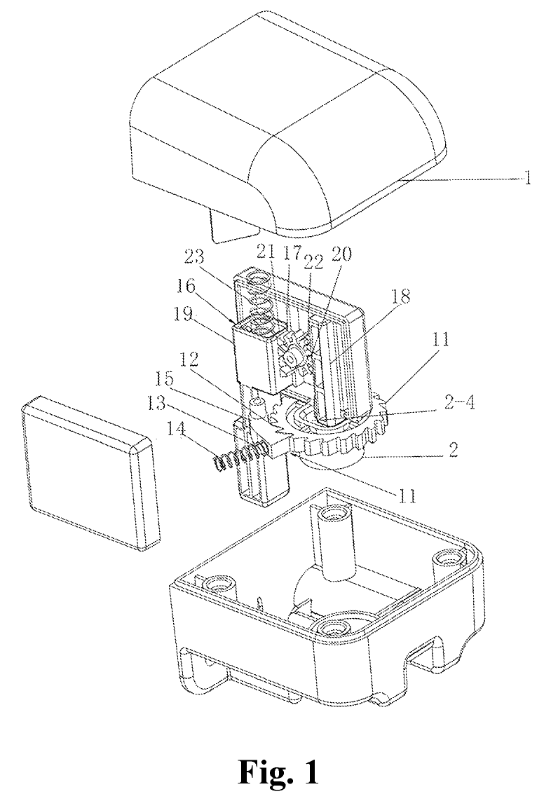

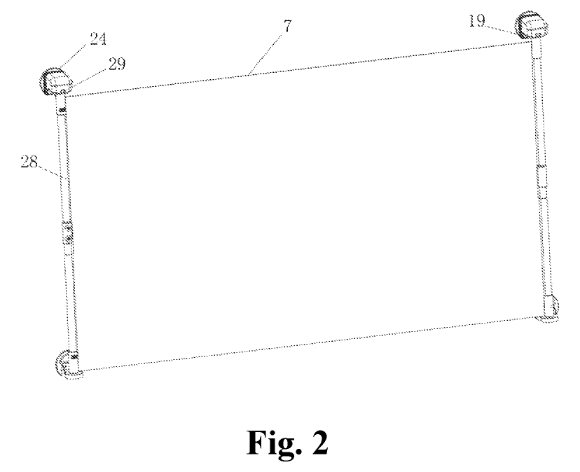

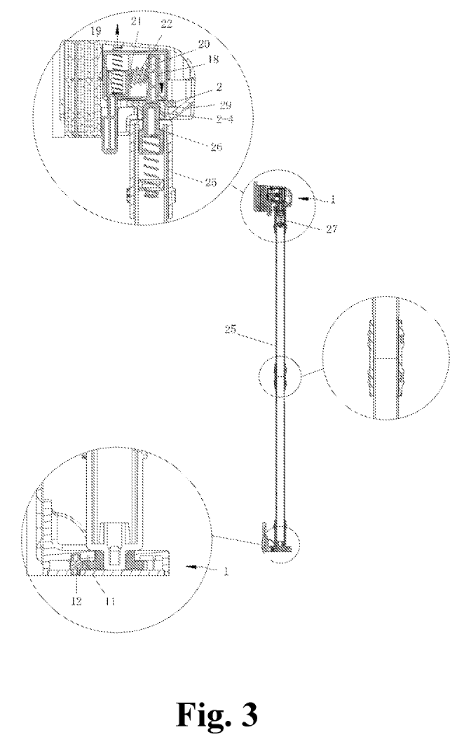

As shown in FIGS. 1-4, a locking seat and a retractable gate barrier having the same, where the locking seat includes a housing 1, a driving seat 2, and a unidirectional adjustment device 17, where the housing 1 is provided with an accommodating cavity 1-1 with a lower opening, an inner bottom wall of the accommodating cavity 1-1 is provided with a positioning hole 1-2, the driving seat 2 is arranged in the accommodating cavity 1-1, and the unidirectional adjustment device 17 is configured to rotate the driving seat 2 unidirectionally.

In this embodiment, the retractable gate barrier includes a folding rod 25 and mounting seats 24 located at upper and lower ends of the folding rod 25, where an unlocking device 16 is arranged on the upper mounting seat 24, unidirectional rotation of the folding rod 25 is implemented by the unidirectional positioning device, so that the cloth 7 on the surface of the folding rod 25 may be adjusted and wound. In practical use, a length of the cloth 7 may be set to exceed a predetermined value, and meanwhile, the tightness and length of the cloth 7 may be adjusted in time, thereby improving applicability of the folding gate barrier; and at the same time, the folding rod 25 is detachably arranged, so that the size of the retractable gate barrier may be effectively reduced, which is convenient to transport and meanwhile convenient to mount. The mounting seat 24 may be fixed to a corresponding position by gluing or using a screw.

As shown in FIG. 1, in this embodiment, the unidirectional positioning device includes an adjustment ratchet wheel 11 arranged on the driving seat 2, and an adjustment pawl 12 swingably mounted on the housing 1. The adjustment pawl 12 may move toward the adjustment ratchet wheel 11. Certainly, in specific embodiments, other locking manners may alternatively be used for implementation.

Further, in this embodiment, the adjustment pawl 12 is provided with a pivoting portion 15. The adjustment pawl 12 is provided with a positioning portion 13 arranged at an end thereof distal from the pivoting portion 15. A first abutting spring 14 is arranged between the positioning portion 13 and the housing 1. One end of the first abutting spring 14 abuts against the positioning portion 13, and another end abuts against the housing 1, whereby the first abutting spring 14 applies an elastic force to bias the adjustment pawl 12 toward the adjustment ratchet wheel 11, thereby locking the adjustment ratchet wheel 11, and preventing the folding rod 25 from rotating.

Further, in this embodiment, the housing 1 is provided with an unlocking device 16. The unlocking device 16 includes an ejector rod 18 and an adjustment device 17. The driving seat 2 is provided with a limiting hole. The adjustment device 17 may drive the ejector rod 18 to switch between a position of extending into the limiting hole and a position of exiting the limiting hole.

In this embodiment, the adjustment device 17 includes a button 19 slidably mounted on the housing 1. Opposite end faces of the ejector rod 18 and the button 19 are respectively provided with a first rack 20 and a second rack 21. A gear 22 simultaneously engaged with the first rack 20 and the second rack 21 are arranged therebetween. When the button 19 moves upward, the first rack 20 drives the gear 22 to rotate clockwise, and then drives the ejector rod 18 to move downward, that is, toward the position of extending into the limiting hole, thereby ejecting the folding rod 25 and facilitating detachment of the folding rod 25. Further, a second abutting spring 23 is arranged between the button 19 and the housing 1, to apply an elastic force to the button 19 to move downward, so that the ejector rod 18 is in the position of exiting the limiting hole. Specifically, the ejector rod 18, the button 19, and the gear 22 are an integrated module (that is, being mounted and fixed through the housing 1). Through modularizing, the ejector rod, the button, and the gear may be conveniently mounted and fixed in the housing 1.

Further, at least one mounting seat 24 of the two mounting seats 24 of the retractable gate barrier is provided with a locking seat. The folding rod 25 may rotate in a predetermined direction. There are at least two folding rods 25. A cloth 7 is arranged between the two folding rods 25.

Preferably, the folding rod 25 is composed of at least two rod bodies 28. The rod bodies 28 are detachably connected. For example, a retractable rod structure is used (when a retractable structure is used, the cloth 7 is detachably mounted), or a structure of the folding rod 25 is used (preferably, the folding rod 25, which can directly fix the cloth 7). Alternatively, fixing and mounting may be performed by a screw, thereby saving transportation costs.

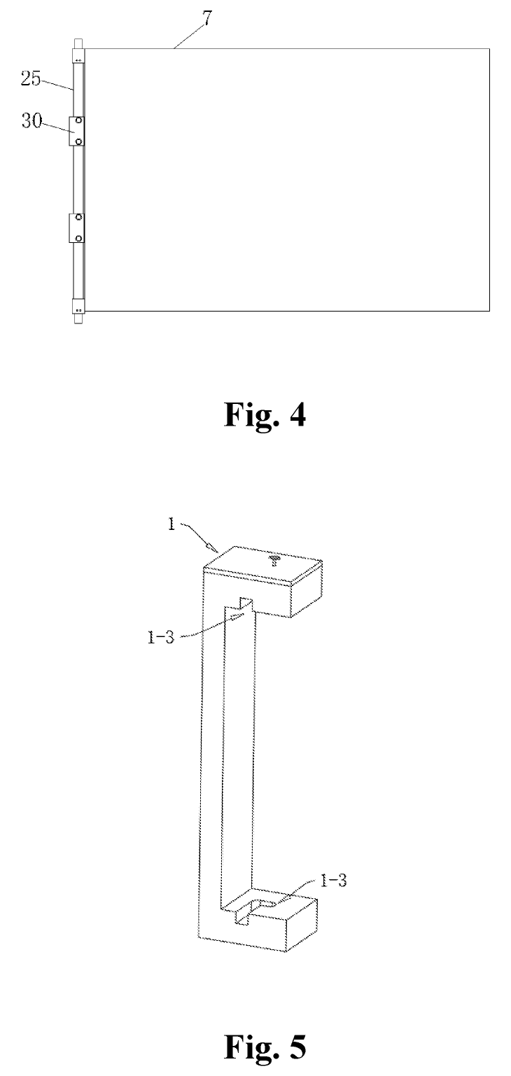

Further, as shown in FIG. 4, in some embodiments, the folding rod 25 is composed of three rod bodies 28. The rod bodies 28 are detachably connected through adapters 30.

Preferably, an upper end of the folding rod 25 is provided with a positioning pin 26 that is slidably mounted in the limiting hole. A shape of the positioning pin 26 is matched with that of the limiting hole. A third abutting spring 27 is arranged between the folding rod 25 and the positioning pin 26. The third abutting spring 27 may apply an elastic force to the positioning pin 26 to extend into the limiting hole. In some other embodiments, the housing 1 may not be provided with an unlocking device 16. The unlocking device 16 may be arranged on the folding rod 25. Through the unlocking device 16, the positioning pin 26 may be pressed down, and then the folding rod 25 can be taken out.

### Embodiment Two

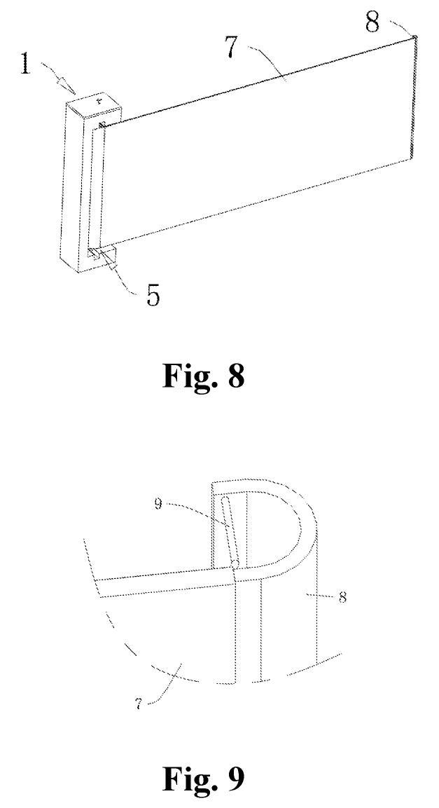

As shown in FIGS. 5-12, a locking seat and a retractable gate barrier having the same, where the locking seat includes a housing 1, a driving seat 2, and a unidirectional adjustment device configured to drive the driving seat 2 to rotate unidirectionally. The housing 1 is vertically arranged. An upper cantilevered portion of the housing 1 is provided with an accommodating cavity 1-1 with a lower opening. An inner bottom wall of the accommodating cavity 1-1 is provided with a positioning hole 1-2. The driving seat 2 is arranged in the accommodating cavity 1-1. The unidirectional adjustment device includes a torsion spring 3 and a locking structure 4, where an inner end of the torsion spring 3 is connected to the driving seat 2, and an outer end is connected to the accommodating cavity 1-1, and the torsion spring is in a pre-tensioned state. The locking structure 4 is movably connected between a first position and a second position of the driving seat 2 for vertical movement. When the locking structure 4 is in the first position, the locking structure 4 is inserted into and locked in the positioning hole 1-2, so that the driving seat 2 and the torsion spring 3 are locked. After an external component (for example, an insertion rod 6 described below) is inserted between the locking structure 4 and the driving seat 2 along an opening, the locking structure 4 is pushed by continuously inserting the external component, so that the locking structure 4 can be switched from a first position to a second position, and therefore, the locking structure 4 disengages from the positioning hole 1-2, the driving seat 2 and the torsion spring 3 are unlocked, and then the driving seat 2 drives the external component to rotate under torsion (restoring force) of the torsion spring 3.

Preferably, as shown in FIGS. 7-9, the retractable gate barrier includes a rotating shaft 5 and a locking seat, where the rotating shaft 5 is rotatably and adjustably mounted at the lower opening of the housing 1. A top of the rotating shaft 5 is provided with a mounting groove. A vertically movable insertion rod 6 is arranged in the mounting groove. A flexible cloth 7 is wound around the periphery of the rotating shaft 5. A hard U-shaped fixing plate 8 is fixed to an outer end of the cloth 7. An edge of one end of the U-shaped fixing plate 8 is fixed to the cloth 7, and the other end is cantilevered. A notch of the U-shaped fixing plate 8 faces the rotating shaft 5.

Further, an adjustment structure is arranged at the notch of the U-shaped fixing plate 8. When pressed, the adjustment structure is triggered to drive the insertion rod 6 to push the locking structure 4 upward along the lower opening, to switch from the first position to the second position, so that the driving seat 2 drives the rotating shaft 5 to rotate under torsion of the torsion spring 3 to tension the cloth 7.

Specifically, upper and lower end of the rotating shaft 5 both protrude from the cloth 7. Preferably, the top of a lower cantilevered portion and the bottom of an upper cantilevered portion of the housing 1 are provided with limiting grooves 1-3 (as shown in FIG. 5) configured to mount an external component (such as the rotating shaft 5), and the limiting grooves 1-3 have side openings in communication with a side wall surface of the housing 1, where the limiting groove 1-3 takes an L shape as a whole from the perspective of a top view, the two limiting grooves 1-3 are aligned up and down, and the limiting groove 1-3 located at the upper cantilevered portion is in communication with the lower opening of the accommodating cavity 1-1.

When the gate barrier needs to be arranged, the rotating shaft 5 wound with the cloth 7 is assembled between the lower cantilevered portion and the upper cantilevered portion of the housing 1 along the limiting grooves 1-3, and ends of the rotating shaft 5 and the limiting grooves 1-3 are in a pre-assembled state, so that the rotating shaft 5 is rotatable, but cannot move up and down as a whole. Then, by pulling the cloth 7 to unwind the cloth 7 to a required length, buckling the U-shaped fixing plate 8 at the outer end of the cloth 7 on a structural member at a target position, to trigger the adjustment structure through a pressing force that is applied by the structural member to an inner side of the notch of the U-shaped fixing plate 8 in a buckling process, the insertion rod 6 in the rotating shaft 5 may be driven to be inserted into the accommodating groove along the lower opening, the insertion rod 6 may then push the locking structure 4 upward, so that the locking structure 4 switches from the first position to the second position, thereby unlocking the driving seat 2 and the torsion spring 3. In this case, the driving seat 2 may drive the rotating shaft 5 to rotate under torsion of the torsion spring 3 to tension the cloth 7. It should be noted that in a process of loosening and restoring of the torsion spring 3, a rotation direction of the driving seat 2 driven by the torsion spring 3 is opposite to a rotation direction of the rotating shaft 5 when the cloth 7 is pulled out.

With such a design, the gate barrier is composed of the locking seat and the rotating shaft 5 in a split manner, and the whole structure is relatively small in size. In the process of pulling out the cloth 7 (that is, the separation cloth) of the retractable gate barrier, the torsion spring 3 does not participate in operation, and it is unnecessary to overcome the torsion force in the process of pulling out the cloth 7, which is beneficial for operation of users with less strength. After the cloth 7 is pulled to a suitable position, by buckling the U-shaped fixing plate 8 at the outer end of the cloth 7 on the structural member at the target position, the adjustment structure may be triggered, so that the torsion spring 3 is unlocked and drives the rotating shaft 5 to rotate through the driving seat 2 (this rotation direction is opposite to an unwinding direction of the cloth 7). The U-shaped fixing plate 8 at the end of the cloth 7 is in a buckled state, so that the cloth 7 is in a tensioned state due to the torsion force of the torsion spring 3, leading to an extremely simple and safe operation process.

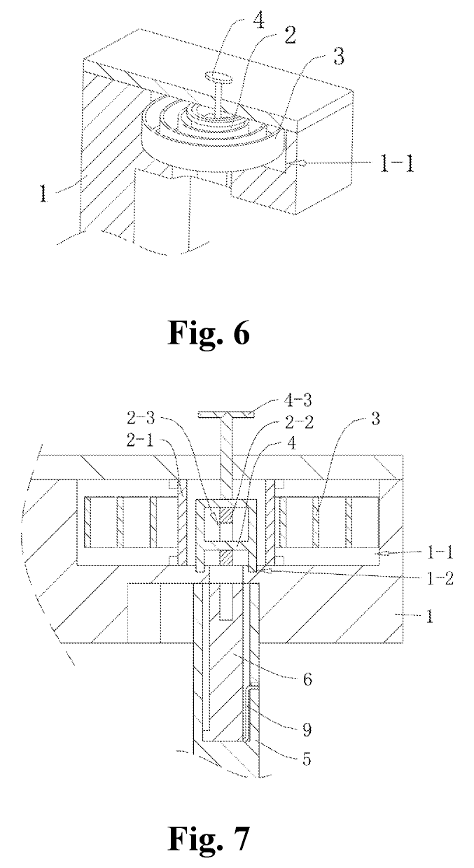

Preferably, as shown in FIGS. 6, 7, and 10, the driving seat 2 includes a drum body 2-1 and a support plate 2-2, where the drum body 2-1 is vertically arranged and takes the shape of a cylinder that extends vertically from top to bottom, and a lower port of the drum body 2-1 faces the lower opening of the accommodating cavity 1-1. The support plate 2-2 is vertically arranged in the drum body 2-1, and fixed to an inner wall of the drum body 2-1 along a radial direction of the drum body 2-1. The locking structure 4 is located on an inner side of the drum body 2-1, and is movably connected to the support plate 2-2.

Preferably, in some embodiments, a structure such as a positioning groove or a positioning ring configured to position the drum body 2-1 may be further arranged on an inner side of the accommodating cavity 1-1. The positioning groove or the positioning ring ensures that the drum body 2-1 may rotate circumferentially, but cannot move up and down.

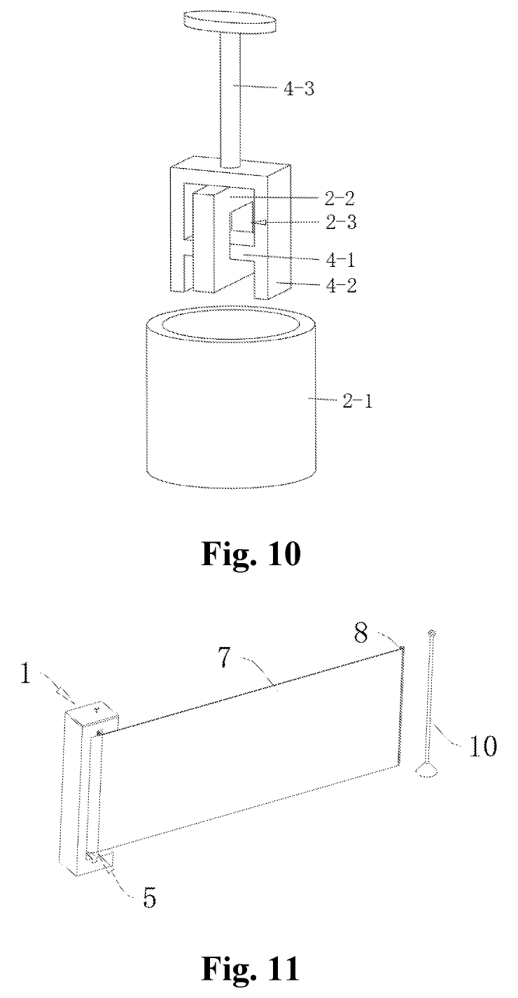

Preferably, as shown in FIG. 10, a plate surface of the support plate 2-2 is provided with an elongated hole 2-3 extending up and down. The locking structure 4 includes a connecting portion 4-1 and insertion portions 4-2, where the connecting portion 4-1 penetrates through the elongated hole 2-3, and is configured to slide vertically within the elongated hole 2-3, so that the locking structure 4 is movably and adjustably connected between the first position and the second position of the driving seat 2.

Generally, when the connecting portion 4-1 contacts an inner bottom wall of the elongated hole 2-3, the locking structure 4 is in the first position. When the connecting portion 4-1 is ejected to contact an inner top wall of the elongated hole 2-3, the locking structure 4 is in the second position.

The insertion portions 4-2 are respectively arranged at two ends of the connecting portion 4-1 and configured to be inserted into the positioning hole 1-2. A gap is defined between the insertion portion 4-2 and the support plate 2-2 for insertion of a component such as the insertion rod 6. When the insertion rod 6 is inserted along the lower opening, the insertion rod 6 can eject the connecting portion 4-1, to implement position adjustment of the locking structure 4. A surface of the insertion rod 6 may contact the support plate 2-2, and under the action of a friction force, the insertion rod 6 may be stably inserted between the insertion portion 4-2 and the support plate 2-2.

Preferably, an upper end of the insertion rod 6 is configured as a U-shaped plug structure, and the U-shaped plug structure is capable of being inserted between the support plate 2-2 and the insertion portion 4-2 along the lower opening. Preferably, an anti-slip structure is arranged at a position, that is not lower than the inner bottom wall of the elongated hole 2-3, of the plate surface of the support plate 2-2. An inner wall surface of the U-shaped plug structure can contact the anti-slip structure, so that the insertion rod 6 and the support plate 2-2 are connected as a whole through the friction force.

Preferably, a guiding structure (such as a guiding structure composed of a guiding block and a guiding groove) is arranged between the insertion rod 6 and an inner wall of the mounting groove of the rotating shaft 5. The guiding structure is configured to limit a moving direction of the insertion rod 6, so that the insertion rod 6 can only move up and down, and cannot rotate.

Preferably, as shown in FIGS. 7 and 10, the locking structure 4 further includes an adjustment portion 4- 3. The adjustment portion 4-3 is connected to the top of the insertion portion 4-2. The top end of the adjustment portion 4-3 extends out of the housing 1. The adjustment portion 4-3 and the driving seat 2 are coaxial with each other. In practical use, a state of the locking structure 4 may be observed through the adjustment portion 4-3, and a position of the locking structure 4, a pre-tightening force of the torsion spring 3, or the like may be adjusted through operations such as pressing, rotating the adjustment portion 4-3.

Preferably, the cloth 7 is provided with an interlayer therein. A channel extending along a length direction is formed in the cloth 7 through the interlayer. The adjustment structure includes a traction rope 9. The traction rope 9 is movably inserted into the interlayer. One end of the traction rope 9 penetrates through a side wall of the rotating shaft 5 and extends downward to connect a bottom of the insertion rod 6 as shown in FIG. 7, and another end extends out of the interlayer of the cloth 7 and is connected to an outer edge of a cantilevered end of the U-shaped fixing plate 8 after crossing an opening portion of the notch of the U-shaped fixing plate 8 as shown in FIG. 9.

Under normal conditions, due to gravity of the insertion rod 6, the insertion rod 6 pulls the traction rope 9 to be in a straightened state, so that the traction rope 9 is in the straightened state at the notch of the U-shaped fixing plate 8, forming a lock type triggering structure using the traction rope 9 as a side length as shown in FIG. 9. By pressing the traction rope 9 at the notch of the U-shaped fixing plate 8, the traction rope 9 that is pressed migrates to an inner wall of the notch, so that the traction rope 9 is forced to move and pulls the insertion rod 6, and therefore, the insertion rod 6 moves upward to trigger unlocking of the locking seat.

Certainly, in some other embodiments, the traction rope 9 may be replaced with an elastic rope with low elasticity, or any other existing triggering structure that can drive the insertion rod 6 to move upward after being triggered.

Preferably, as shown in FIG. 11, in some embodiments, the retractable gate barrier further includes a positioning post 10 fixed to a ground foundation. An outer peripheral surface of the positioning post 10 is approximately matched with the notch of the U-shaped fixing plate 8. When the U-shaped fixing plate 8 is pulled to be buckled on the outer peripheral surface of the positioning post 10, the adjustment structure is triggered, and the U-shaped fixing plate 8 can be limited by the outer peripheral surface of the positioning post 10, so that the U-shaped fixing plate 8 cannot be separated from the positioning post 10, thereby ensuring personnel safety.

In such a design, the positioning post 10 is matched with the locking seat and the rotating shaft 5 for use. Using the locking seat and the positioning post 10 as two end nodes of a space partitioning region, the cloth 7 is arranged and tightened between the locking seat and the positioning post 10, so that space separation may be implemented. This design is particularly suitable for short-distance space separation.

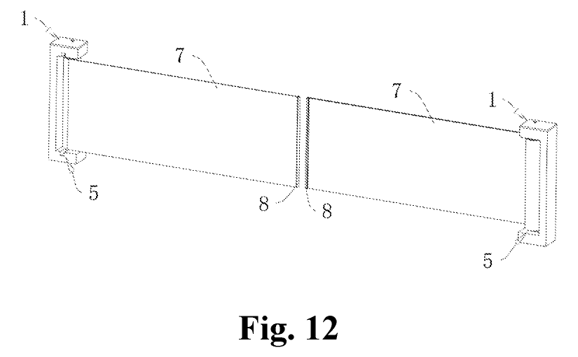

Preferably, as shown in FIG. 12, in some embodiments, the retractable gate barrier includes two rotating shafts 5 and two locking seats. Each of the two rotating shafts 5 corresponds to a respective one of the two locking seats. The respective adjustment structures are triggered when the U-shaped fixing plates 8 in the two rotating shafts 5 are clamped together.

In such a design, the two locking seats are respectively used as two end nodes of a space partitioning region. The cloth 7 at the rotating shaft 5 in the two locking seats is pulled out, and the U-shaped fixing plates 8 at outer ends of the two clothes 7 are clamped together. This design is particularly suitable for long-distance space separation.

The foregoing description is merely preferred embodiments of the present disclosure, and does not limit the patent scope of the present disclosure. All equivalent structural changes made by using the contents of the specification and drawings of the present disclosure under the inventive concept of the present disclosure, or directly/indirectly applied in other related technical fields are included in the patent protection scope of the present disclosure.

What is claimed is:

1. A locking seat, comprising:
a housing (1), provided with an accommodating cavity (1-1) with a lower opening, wherein an inner bottom wall of the accommodating cavity (1-1) is provided with a positioning hole (1-2);
a driving seat (2), arranged in the accommodating cavity (1-1); and
a unidirectional adjustment device, configured to rotate the driving seat (2) unidirectionally.

2. The locking seat according to claim 1, wherein the unidirectional adjustment device comprises an adjustment ratchet wheel (11) arranged on the driving seat (2), and an adjustment pawl (12) swingably mounted on the housing (1), and the adjustment pawl (12) moves toward the adjustment ratchet wheel (11).

3. The locking seat according to claim 2, wherein the adjustment pawl (12) is provided with a pivoting portion (15), the adjustment pawl (12) is provided with a positioning portion (13) arranged at an end thereof distal from the pivoting portion (15), a first abutting spring (14) is arranged between the positioning portion (13) and the housing (1), one end of the first abutting spring (14) abuts against the positioning portion (13), and another end abuts against the housing (1), whereby the first abutting spring (14) applies an elastic force to bias the adjustment pawl (12) toward the adjustment ratchet wheel (11).

4. The locking seat according to claim 1, wherein the unidirectional adjustment device comprises:
a torsion spring (3) in a pre-tensioned state; wherein an inner end of the torsion spring (3) is connected to the driving seat (2), and an outer end is connected to an inner wall of the accommodating cavity (1-1); and
a locking structure (4), movably connected between a first position and a second position of the driving seat (2) for vertical movement;
when the locking structure (4) is in the first position, the locking structure (4) is inserted into and locked in the positioning hole (1-2), so that the driving seat (2) and the torsion spring (3) are locked; and
after an external component pushes the locking structure (4) along an opening to switch from the first position to the second position, the locking structure (4) disengages from the positioning hole (1-2), whereupon the driving seat (2) rotates under torsion of the torsion spring (3), driving the external component.

5. The locking seat according to claim 4, wherein the driving seat (2) comprises:
a drum body (2-1) extending vertically from top to bottom, wherein a lower port of the drum body (2-1) faces the lower opening of the accommodating cavity (1-1); and
a support plate (2-2), vertically arranged in the drum body (2-1), and fixed to an inner wall of the drum body (2-1) along a radial direction of the drum body (2-1), wherein the locking structure (4) is located on an inner side of the drum body (2-1), and movably connected to the support plate (2-2).

6. The locking seat according to claim 5, wherein a plate surface of the support plate (2-2) is provided with an elongated hole (2-3) extending up and down, and the locking structure (4) comprises:
a connecting portion (4-1), disposed through the elongated hole (2-3), and is configured to slide vertically within the elongated hole (2-3); and
insertion portions (4-2), which are respectively arranged at two ends of the connecting portion (4-1) and configured to be inserted into the positioning hole (1-2), and a gap is defined between the insertion portion (4-2) and the support plate (2-2).

7. A retractable gate barrier, comprising a rotating shaft (5) and the locking seat according to claim 4, wherein
a top of the rotating shaft (5) is provided with a mounting groove, and a vertically movable insertion rod (6) is arranged in the mounting groove; and
a cloth (7) is wound around a periphery of the rotating shaft (5), a U-shaped fixing plate (8) is fixed to an outer end of the cloth (7), a notch of the U-shaped fixing plate (8) faces the rotating shaft (5), an adjustment structure is arranged at the notch of the U-shaped fixing plate (8), when pressed, the adjustment structure is triggered to drive the insertion rod (6) to push the locking structure (4) upward along a lower opening, to switch from a first position to a second position, so that the driving seat (2) drives the rotating shaft (5) to rotate under torsion of the torsion spring (3) to tension the cloth (7).

8. The retractable gate barrier according to claim 7, wherein the cloth (7) is provided with an interlayer therein, the adjustment structure comprises a traction rope (9), one end of the traction rope (9) penetrates through a side wall of the rotating shaft (5) and extends downward to connect a bottom of the insertion rod (6), and another end extends out of the interlayer of the cloth (7) and is connected to an outer edge of a cantilevered end of the U-shaped fixing plate (8) after crossing the notch of the U-shaped fixing plate (8).

9. The retractable gate barrier according to claim 7, wherein an upper end of the insertion rod (6) is configured as a U-shaped plug structure, and the U-shaped plug structure is configured to push the locking structure (4) along the lower opening.

10. The retractable gate barrier according to claim 9, wherein the retractable gate barrier further comprises a positioning post (10) fixed to a ground foundation, an outer peripheral surface of the positioning post (10) is matched with the notch of the U-shaped fixing plate (8), when the U-shaped fixing plate (8) is pulled and clamped onto the outer peripheral surface of the positioning post (10), the adjustment structure is triggered, alternatively, two rotating shafts (5) and two locking seats are provided, and each of the two rotating shafts (5) corresponds to a respective one of the two locking seats, so that the respective adjustment structures are triggered when the U-shaped fixing plates (8) in the two rotating shafts (5) are clamped together.
